(19) United States
(12) Patent Application Publication
(10) Pub. No.: US 2004/0128536 A1
(43) Pub. Date: Jul. 1, 2004

(54) Method and system for detecting presence of malicious code in the e-mail messages of an organization

(76) Inventors: Ofer Elzam, Kiryat Haim (IL); Shimon Gruper, Haifa (IL); Yanki Margalit, Ramat-Gan (IL); Dany Margalit, Ramat-Gun (IL)

Correspondence Address: DR. MARK FRIEDMAN LTD., C/O Mr. Bill Polkinghorn, Discovery Dispatch, 9003 Florin Way, Upper Marlboro, MD, 20772, US

(21) Appl. No.: 10/331,543

(22) Filed: Dec. 31, 2002

(51) Int. Cl. G06F 11/30

(52) U.S. Cl. 713/201

(57) ABSTRACT

In one aspect, the present invention is directed to a method for detecting presence of malicious code in e-mail messages of an organization, comprising: gathering information related to incoming and/or outgoing e-mail messages of the organization; analyzing the gathered information in order to find common denominators of the gathered information that may indicate about the presence of malicious code within the messages; determining the suspicion of presence of malicious code within the e-mail messages according to the found common denominator, and/or according to the combination of the found common denominators; and upon positively determining a suspicion of presence of malicious code within the e-mail messages, activating an alerting procedure.

In another aspect, the invention is directed to a system for detecting presence of malicious code in the e-mail messages of an organization, comprising: storage means, for storing gathered information about incoming and outgoing e-mail messages; and one or more analyzing facilities, for determining common denominators within the stored information, upon which the possibility of malicious code presence within the e-mail messages is determined.

### FIELD OF THE INVENTION

The present invention relates to the field of malicious code detection. More particularly, the invention relates to a method and system for detecting presence of malicious code in the e-mail messages of an organization.

### BACKGROUND OF THE INVENTION

The more the Internet becomes a popular communication media, the more users use the e-mail services. Therefore, the e-mail becomes one of the major channels for propagation of computer viruses and other malicious codes.

The most common way of propagating malicious code via e-mail is by attaching a malicious code to e-mail messages. In some cases the user has indication about the attached file, e.g., an icon, thus enabling the user to decide whether to activate the executable or not. However in some cases the malicious code is automatically executed at the moment the message is opened or even before, when it is previewed (several e-mail software versions enable the user to preview the e-mail message before opening it). For example, when the e-mail message is in HTML format, displaying the message may also cause executing code (e.g. Java Applet), which may comprise malicious code.

E-mail client software products enable the user to maintain an address book, which comprises the e-mail address of the correspondents the user uses to communicate with. Also, e-mail clients store selected sent and/or received e-mail messages, which also comprise the e-mail address of the sender, and in the case of additional recipients, their e-mail address too. This pool of e-mail addresses can be used by a malicious object for propagating malicious code. Moreover, since in many cases the recipient whose address has been taken from an address book or an e-mail message is familiar with the sender, he does not suspect that the received e-mail comprises malicious code.

The traditional way of detecting malicious code in e-mail messages is by examining the e-mail at the local level, i.e. testing each message and its supplementary executables, one by one.

The detection of viruses and other forms of malicious code in a file is carried out by two major ways—virus signature and code analysis. But, actually there are many additional methods known in the art for this purpose.

“Virus signature” is a unique bit pattern that the virus leaves on the infected code. Like a fingerprint, it can be used for detecting and identifying specific viruses. The major drawback of the signature analysis is that the virus should be firstly detected and isolated (by comparing the infected code with the original code). Only then the signature characteristics can be distributed by the anti-virus company among its users.

Another drawback of the signature analysis is that the virus “author” may masquerade the signature by adding non-effective machine language commands between the effective commands. Moreover, the added commands can be selected randomly, thereby preventing a constant signature.

Another way of detecting malicious code within an executable is by analyzing its operation. Since the malicious code is added usually at the end of the executable, and the executable is changed such that the fist command to be executed will be the added code, indicating such an operation pattern can be an indicator for malicious code. The major drawback of code analysis methods is that this is not a simple procedure, and therefore a great deal of effort should be invested until meaningful results are reached. Moreover, a malicious executable which is not a result of an infection is actually a “legitimate” executable, and therefore very difficult to be indicated as malicious.

At the organization level, it is common to put filtering facilities at the gateway of the organization's local network or at the mail server, thereby enabling the examination of each incoming e-mail message before directing it to the user's mailbox. Actually, according to this solution, the organization is treated as an individual user. An example of such a product is the eSafe Gateway, manufactured and distributed by Aladdin Knowledge Systems (www.eAladdin.com). Other organizations filter the viruses only at the users' machines. In this case an infected user, for example due to not updating his anti-virus program, can cause damage to the whole organization.

Since a filtering facility operating at the organization level operates in the same way as the filtering facility of the local level, i.e. examines each incoming e-mail messages separately, it has the same drawbacks as a local filtering facility, as described above.

It is therefore an object of the present invention to provide a method and system for detecting presence of malicious code in the e-mail messages of an organization, which overcomes the individual virus detection methods implemented at the organization level.

It is another object of the present invention to provide a method and system for detecting presence of malicious code in the e-mail messages of an organization, upon which unknown viruses can be detected.

Other objects and advantages of the invention will become apparent as the description proceeds.

### SUMMARY OF THE INVENTION

In one aspect, the present invention is directed to a method for detecting presence of malicious code in e-mail messages of an organization, comprising: gathering information related to incoming and/or outgoing e-mail messages of the organization; analyzing the gathered information in order to find common denominators of the gathered information that may indicate the presence of malicious code within the messages; determining the suspicion of the presence of malicious code within the e-mail messages according to the found common denominator, and/or according to the combination of the found common denominators; and upon positively determining a suspicion of presence of malicious code within the e-mail messages, activating an alerting procedure.

In another aspect, the invention is directed to a system for detecting presence of malicious code in the e-mail messages of an organization, comprising: storage means, for storing gathered information about incoming and outgoing e-mail messages; and one or more analyzing facilities, for determining common denominators within the stored information, upon which the possibility of malicious code presence within the e-mail messages is determined.

### BRIEF DESCRIPTION OF THE DRAWINGS

The present invention may be better understood in conjunction with the following figures:

FIG. 1 schematically illustrates the operation and infrastructure of e-mail delivering and filtering, according to the prior art.

FIG. 2 schematically illustrates filtering activity of incoming e-mail to an organization, according to the prior art.

FIG. 3 schematically illustrates a process and system for detecting suspicious incoming e-mail to an organization, according to a preferred embodiment of the invention.

FIG. 4 schematically illustrates a process and system for detecting suspicious outgoing e-mail from an organization, according to a preferred embodiment of the invention.

### DETAILED DESCRIPTION OF PREFERRED EMBODIMENTS

The term “malicious code” refers herein to all types of software that prevent users from using their computers as they were intended. This includes executables (e.g. Windows EXE files), hostile Java Applets, ActiveX vandals, Trojan horses, scripts, vandals, viruses that are designed to corrupt or steal digital information, and so forth. Consequently, the term “malicious activity” refers herein to any activity of malicious code that is directed to prevent users from using their computers as they were intended.

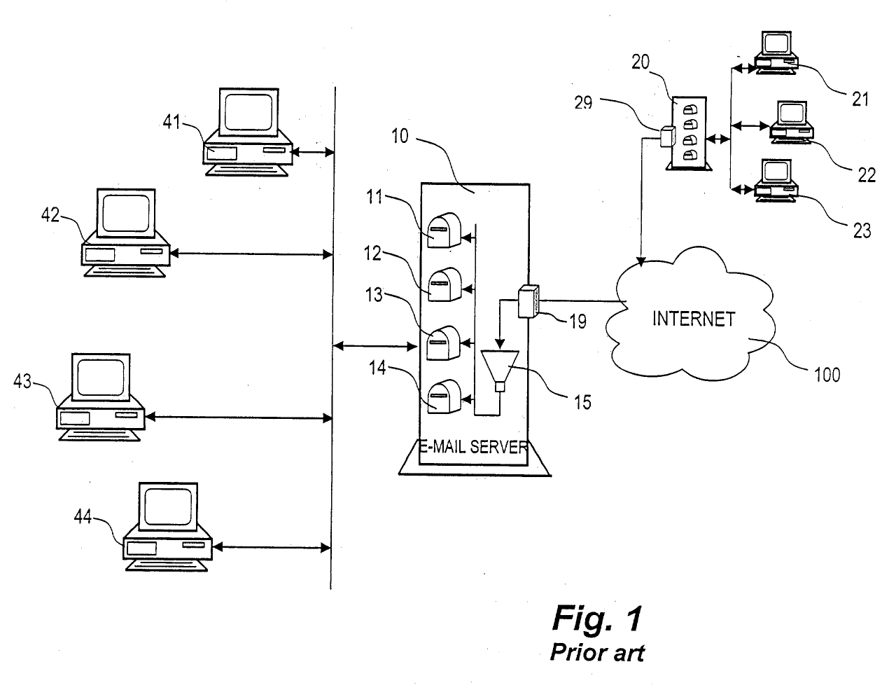

FIG. 1 schematically illustrates the operation and infrastructure of e-mail delivering and filtering, according to the prior art. A mail server 10 maintains e-mail accounts 11 to 14, which belong to users 41 to 44 respectively. Another mail server 20 serves users 21 to 23. The mail server 10 also comprises an e-mail filtering facility 15, for detecting the presence of malicious code within incoming e-mail messages. A mail server communicates with another mail server by a Mail Transfer Agent (MTA). The MTA can be a part of the mail server or a separate entity. Referring to FIG. 1, mail server 10 is coupled with an MTA 19, by which it communicates with the MTA 29 of mail server 20 through the Internet 100.

An e-mail message sent from, e.g., user 21 to, e.g. user 42, passes through the mail server 20, through the Internet 100, until it reaches to mail server 10. At the mail server 10 the e-mail message is scanned by the filtering facility 15, and if no malicious code is detected, then it is stored in e-mail box 12, which belongs to user 42. The next time user 42 opens his mailbox 12 he finds the delivered e-mail message.

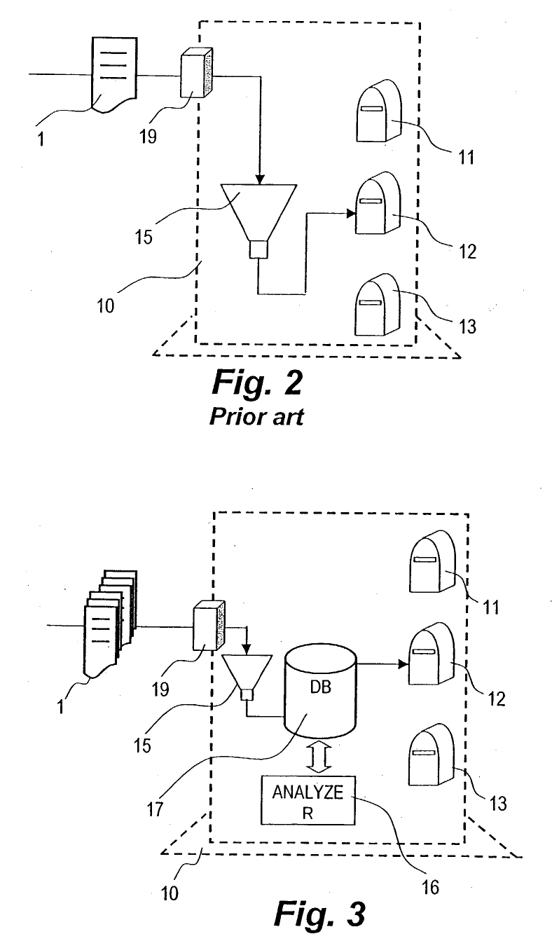

FIG. 2 schematically illustrates filtering activity of incoming e-mail to an organization, according to the prior art. An e-mail message 1 that arrives to the mail server 10 of an organization is scanned by the filtering facility 15. If no malicious code is found within the e-mail message 1, then the e-mail message is delivered to the appropriate e-mail client within the organization, otherwise an appropriate message is sent to the recipient. Of course instead of or in addition to notifying the recipient about the found malicious code, the filtering facility 15 may remove the malicious files from the e-mail message, or to eliminate the malicious code from the files.

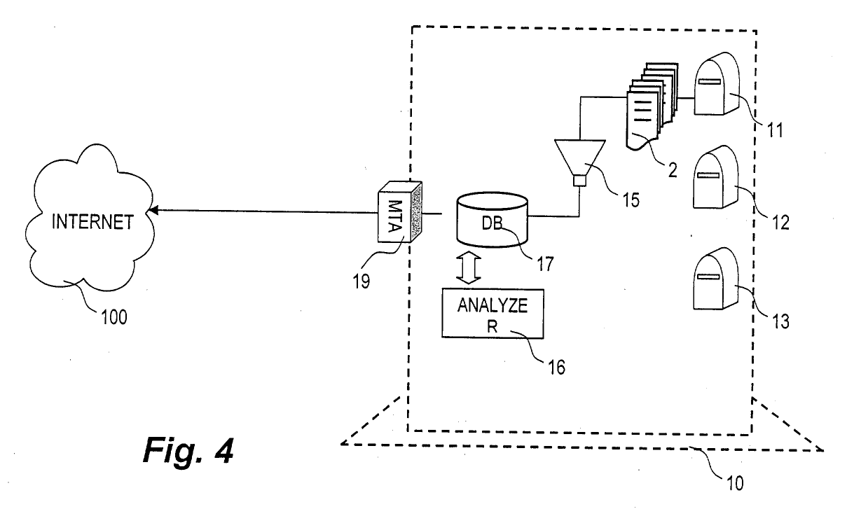

FIG. 3 schematically illustrates a process and system for detecting suspicious incoming e-mail to an organization, according to a preferred embodiment of the invention.

According to a preferred embodiment of the invention, detection of malicious activity at the organization level is carried out by determining a common denominator within the e-mail addresses of outgoing/incoming e-mail messages, in contrary to the prior art where each incoming e-mail message is examined individually.

According to a preferred embodiment of the invention, the information used for detecting malicious activity are the e-mail addresses of the incoming/outgoing mail of the organization.

The e-mail format comprises fields, e.g., the sender's e-mail address, the recipient(s)' e-mail address, the e-mail message text, and so forth. The e-mail address also comprises fields.

For example:

“owner_name“<mailbox_name@mail_server_name> is a common e-mail address format. Joseph Smith”<jsmith@hotmail.com> is an e-mail address that corresponds to this format.

According to a preferred embodiment of the invention, if the owner_name field of a group of messages that has been received from a source are ordered in an alphabetical order, it might indicate that the source is un-trusted, and therefore messages from this source may comprise malicious content. The same sustains for the mailbox name field. Thus, incoming e-mail messages from a source that are ordered in alphabetical order can be treated as suspicious.

Referring now to FIG. 3, a database 17 stores information regarding incoming and/or outgoing e-mail messages 1 (e.g. the destination e-mail addresses of incoming e-mail messages and the e-mail address of their source). An analyzing facility 16 (such as a software module) retrieves the information gathered within database 17, and analyzes it in order to find a common denominator, e.g. that the messages that come from a specific sender are ordered in alphabetical order.

If the analyzing facility 16 indicates that the incoming e-mail messages and/or their sender are suspicious, the delivery of the e-mail messages may be temporarily suspended until the suspicion can be sustained or refuted.

Of course a filtering facility 15 may be employed in order to analyze incoming e-mail messages on an individual basis.

Since the data stored within the database 17 is of temporary nature, it can be removed from the database after a while, e.g. 12 hours.

Examples of common denominators within incoming e-mail messages:

The name of the addressees of the incoming e-mail messages from a sender are ordered in alphabetical order.

The e-mail addresses of the incoming e-mail messages from a sender are ordered in alphabetical order.

The majority of the addressees of incoming messages from a sender are not valid addresses at the organization (although the mail server name is valid, otherwise the e-mail messages would not be received at this mail server).

Examples of common denominators within incoming or outgoing e-mail messages:

a text and/or attachment repeated in the incoming/outgoing mail messages;

the attachment(s) is repeated in the incoming/outgoing mail messages;

the name(s) of the attachment(s) is repeated in the incoming/outgoing mail messages.

It should be noted that the term database refers herein to any storage and retrieval means, e.g. memory array, etc.

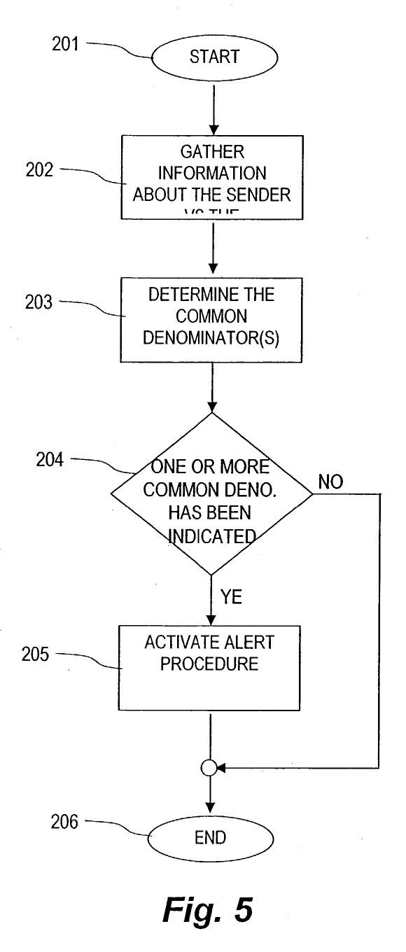

FIG. 4 schematically illustrates a process and system for detecting suspicious outgoing e-mail from an organization, according to a preferred embodiment of the invention. While analyzing incoming e-mail messages may indicate about attempts to harm the organization, analyzing outgoing e-mail may indicate about malicious activity that already has been performed within the organization.

Referring to FIG. 4, information about e-mail messages 2 that have been sent from e-mail box 11 is gathered at database 17. An analyzing facility 16 tries to find common denominator(s) within the data, and if such a common denominator has been found, heuristic methods are implemented in order estimate the possibility of prior activity of malicious code, due which the e-mail has been sent.

Examples of common denominators within outgoing e-mail messages:

The addressees or e-mail addresses of outgoing e-mail messages from a sender within the organization are ordered in alphabetical order.

The majority of the addressees of outgoing e-mail messages from a sender within the organization exist in the sender's address book.

The majority of the addressees of outgoing e-mail messages from a sender within the organization exist in the organization's address book.

The majority of the addressees of outgoing e-mail messages from a sender within the organization do not exist in the organization's address book

The majority of the addressees of outgoing e-mail messages from a sender within the organization are ordered as the order of the address book of the sender/organization.

The outgoing e-mail message(s) have been sent while the computer is idle (e.g. the user is out of launch).

FIG. 5 is a high-level flowchart of a process of detecting suspicious incoming/outgoing e-mail message, according to a preferred embodiment of the invention.

The process starts at step 201, where incoming/outgoing e-mail message(s) arrive to the mail server in order to be posted to their destination.

At step 202, information about the destination(s), the source, and other characteristics of incoming/outgoing e-mail messages is gathered.

At step 203, the gathered information is analyzed in order to determine common denominator(s) within the data.

At step 204, if one or more common denominator has been indicated, then heuristic method(s) that use the common denominator(s) are implemented, in order to indicate suspicion of malicious presence in said incoming/outgoing e-mail messages.

If suspicion of malicious presence has been indicated, the process continues with step 205, where an alert procedure is activated, otherwise the process continues with step 206, where it ends.

According to a preferred embodiment of the invention, a system for detecting presence of malicious code in e-mail messages of an organization should comprise:

storage means, for storing gathered information about incoming and outgoing e-mail messages; and

at least one analyzing facility, e.g. software application, for determining at least one common denominator within the stored information, and indicating the possibility of malicious code presence within the e-mail messages by at least one of the determined common denominators and/or by the combination of at least two of the determined common denominators.

The information may be collected by the mail servers of the organization, and/or by the client machines of the organization. In the later case, the information may be transferred to the analyzing facility, or analyzed by a local analyzing facility, and only the conclusions (i.e. the found common denominators) are transferred to a main analyzing facility. As known to the skilled person, a variety of architectures can be implemented in such a system.

Those skilled in the art will appreciate that the invention can be embodied by other forms and ways, without losing the scope of the invention. The embodiments described herein should be considered as illustrative and not restrictive.

1. A method for detecting presence of malicious code in incoming and/or outgoing e-mail messages of an organization, said method comprising:
a) gathering information related to said e-mail messages;
b) analyzing the gathered information in order to find at least one common denominator of the gathered information that may indicate the presence of malicious code within the messages;
c) determining the suspicion of presence of malicious code within said e-mail messages according to at least one found common denominator, and/or according to the combination of a plurality of found common denominators; and
d) upon positively determining a suspicion of presence of malicious code within said e-mail messages, activating an alerting procedure.

2. A method according to claim 1, wherein said information comprising at least one filed of said e-mail messages.

3. A method according to claim 1, wherein said information comprising at least one filed of the e-mail address of said e-mail messages.

4. A method according to claim 1, wherein said at least one common denominator of said incoming e-mail messages is selected from a group comprising:
the content of a field of the addressees e-mail messages sent from a sender are ordered in alphabetical order;
the e-mail addresses of the e-mail messages sent from a sender are ordered in alphabetical order;
the majority of the addressees of the e-mail messages from a sender are not valid addresses at said organization;
a text and/or attachment(s) is repeated in said e-mail messages;
thereby enabling indicating attempts to send malicious code from outside the organization.

5. A method according to claim 1, wherein said at least one common denominator of outgoing e-mail messages is selected from a group comprising:
the data of at least one field of the destination e-mail addresses of the e-mail messages from a sender within said organization are ordered in alphabetical order;
the majority of the addressees of the outgoing e-mail messages from a sender within said organization exist in the sender's address book;
the majority of the addressees of the outgoing e-mail messages from a sender within said organization do not exist in the sender's address book;
the majority of the addressees of the outgoing e-mail messages from a sender within said organization exist in the organization's address book;
the majority of the addressees of the outgoing e-mail messages from a sender within the organization are ordered as the order of the address book of the sender;
the majority of the addressees of the outgoing e-mail messages from a sender within the organization are ordered as the order of the address book of the organization;
the outgoing e-mail message(s) has been sent while the computer is idle;
a text and/or attachment is repeated in said e-mail messages;
thereby enabling indicating presence of malicious code within outgoing e-mail messages from said organization.

6. A system for detecting presence of malicious code in incoming and/or outgoing e-mail messages of an organization, said system comprising:
storage means, for storing gathered information about incoming and outgoing e-mail messages; and
at least one analyzing facility, for determining at least one common denominator within the stored information, and indicating the possibility of malicious code presence within said e-mail messages by at least one of the determined common denominators and/or by the combination of at least two of the determined common denominators.

7. A system according to claim 6, further comprising:
at least of one local analyzer, operative at the corresponding client machine(s) of said organization, for analyzing local information, and
at least one central analyzer, for analyzing information at the organization level, said at least one local analyzer accessible by said at least one central analyzer.

8. A system according to claim 6, wherein said storage means reside in at least one mail server of said organization.

9. A system according to claim 6, wherein said storage means reside at the client machine(s) of said organization.

10. A system according to claim 6, wherein said storage means are accessible by at least one mail server of said organization.

11. A system according to claim 6, wherein said analyzing facility is a software application.
